(19) United States
(12) Patent Application Publication
(10) Pub. No.: US 2003/0134669 A1
(43) Pub. Date: Jul. 17, 2003

(54) Portable telephone terminal with helical antenna applied to hinge dummy

(75) Inventors: Joon-Ho Byun, Suwon-shi (KR); Byung-Man Lim, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-Do (KR)

(21) Appl. No.: 10/335,714

(22) Filed: Jan. 2, 2003

(30) Foreign Application Priority Data
Jan. 12, 2002 (KR) P2002-1932

(51) Int. Cl. H04B 1/38

(52) U.S. Cl. 455/575; 455/90; 455/351

(57) ABSTRACT

Disclosed is a portable telephone terminal comprising (A) a main housing, (B) a folder housing, and (C) hinge means for rotatably connecting the folder housing to the main housing and including a hinge dummy installed at one side of a hinge axis between the main housing and the folder housing and a hinge module installed on the opposite side to the hinge dummy and providing a force for opening and closing the folder housing from and into the main housing, in characterized in that the portable telephone terminal comprises (a) an outer cylindrical surface provided in a direction of the hinge axis on one side of the hinge dummy, and (b) an antenna member coiled more than one time around the outer cylindrical surface to be fixed to the outer cylindrical surface, one end of the antenna member being connected to a printed circuit board of the main housing so as to form a power-feeding portion.

### PRIORITY

This application claims priority to an application entitled “PORTABLE PHONE WITH HELICAL ANTENNA APPLIED TO HINGE DUMMY”, filed in the Korean Industrial Property Office on Jan. 12, 2002 and assigned Serial No. 2002-1932, the contents of which are herein incorporated by reference.

### BACKGROUND OF THE INVENTION

1. Field of the Invention

The present invention relates to a portable telephone terminal, and more particularly to a portable telephone provided with a helical antenna applied to a hinge axis.

2. Description of the Related Art

Usually, a portable telephone terminal refers to a terminal such as a digital phone, a cellular phone, a PDA (Personal Digital Assistant), etc. This portable telephone terminal essentially comprises an antenna unit, a data input/output unit, and a data transmitting/receiving unit so as to communicate with a counterpart. A microphone unit and a speaker unit are used as the data transmitting/receiving unit, respectively. Further, a plurality of keys for inputting data and a LCD (Liquid Crystal Display) for displaying information are respectively used as the data input/output means. As the conventional antenna unit, a helical antenna is mainly employed. Further, a whip antenna is used as an auxiliary antenna. The whip antenna is extended and retracted.

In order to miniaturize the main body of the portable telephone terminal, an internal type antenna installed within the main body tends to be employed. Herein, various antennas such as a planar inverted F-type antenna (referred to as a “PIFA”) and a chip type antenna can be used as the internal type antenna. The internal type antenna requires an internal space for accommodating the internal type antenna within the main body of the portable telephone terminal.

A conventional portable telephone terminal employing the aforementioned helical antenna will be described in detail. The conventional portable telephone terminal comprises a main body, the helical antenna, and the whip antenna. The helical antenna is provided in an antenna housing extending from an edge of one side surface of the main body in a lengthwise direction. The whip antenna is drawn out of the main body of the portable telephone terminal so as to pass through the helical antenna within the antenna housing. FIG. 5a shows the conventional helical antenna 44 installed in the portable telephone terminal. However, the conventional whip antenna is not shown in FIG. 5a.

The conventional helical antenna 44 is accommodated within the antenna housing 42 so that the helical antenna extends in a lengthwise direction from the main housing 40 or in a lengthwise direction of the antenna housing. One end of the helical antenna 44 is connected to a power-feeding portion 46.

However, the portable telephone terminal employing the conventional helical antenna 44 protruding from the main housing 40 has several problems as follows. In order to satisfy the antenna characteristics, the conventional helical antenna 44 of the portable telephone terminal usually protrudes from the edge of the housing 40 of the main body. That is, the conventional helical antenna 44 is an external type antenna that protrudes from the main housing 40 of the portable telephone terminal within the antenna housing 42. Specifically, the antenna housing 42 is disposed on one edge of the main housing 40 of the main body of the portable telephone terminal, and then the helical antenna 44 is installed within the antenna housing 42 and the whip antenna (not shown) is pulled in and out on the axis of the helical antenna 44. Therefore, the helical antenna 44 protrudes from the main housing 40 of the portable telephone terminal, thereby limiting the external design of the main housing 40 of the portable telephone terminal and causing inconvenience in carrying the portable telephone terminal. That is, when the portable telephone terminal is taken out of a person's pocket, the protruding helical antenna 44 of the portable telephone terminal interferes with such action. Furthermore, when the portable terminal falls to the ground due to the user's carelessness, the helical antenna 44 and the antenna housing 42 are easily broken.

Further, some conventional internal type antennas, i.e., the PIFA and the chip type antenna, also require an internal space for accommodating the internal type antenna, thus it is difficult to miniaturize the main body 40 of the portable telephone terminal employing the internal type antenna.

### SUMMARY OF THE INVENTION

Therefore, the present invention has been made in view of the above problems, and it is an aspect of the present invention to provide a portable telephone terminal with a helical antenna unit installed within a folder-type portable telephone terminal, more particularly in a region of the hinge axis.

It is another aspect of the present invention to provide a portable telephone terminal provided with a helical antenna installed within a main housing of the portable telephone terminal, thereby satisfying a trend toward miniaturization of the main housing.

It is still another aspect of the present invention to provide a portable telephone terminal provided with a helical antenna installed on a hinge axis, thereby improving portability.

It is a further aspect of the present invention to provide a portable telephone terminal provided with a helical antenna installed on a hinge axis, thereby minimizing limitations on the external design of the portable telephone terminal.

It is a still further aspect of the present invention to provide a portable telephone terminal provided with a helical antenna which is perpendicular to a lengthwise direction of the main housing of the portable telephone terminal.

In is yet another aspect of the present invention to provide a portable telephone terminal provided with a helical antenna installed in a hinge space of a hinge axis within the main housing of the portable telephone terminal.

In accordance with the present invention, the above and other aspects can be accomplished by providing a portable telephone terminal comprising (A) a main housing, (B) a folder housing, and (C) hinge means for rotatably connecting the folder housing to the main housing and including a hinge dummy installed at one side of a hinge axis between the main housing and the folder housing and a hinge module installed on the opposite side to the hinge dummy and providing a force for opening and closing the folder housing from and into the main housing, the portable telephone terminal further comprising (a) an outer cylindrical surface provided in a direction of the hinge axis on one side of the hinge dummy, and (b) an antenna member coiled more than one time around the outer cylindrical surface to be fixed to the outer cylindrical surface, one end of the antenna member being connected to a power-feeding portion.

### BRIEF DESCRIPTION OF THE DRAWINGS

The above and otheraspects, features and other advantages of the present invention will be more clearly understood from the following detailed description taken in conjunction with the accompanying drawings, in which:

FIG. 1 is a perspective view of a folder-type portable telephone terminal shown in its closed state and employing an antenna unit in accordance with a preferred embodiment of the present invention;

FIG. 2 is a perspective view of the portable folder-type telephone terminal shown in its open state and employing the antenna unit in accordance with a preferred embodiment of the present invention;

FIG. 3 is a partially cut-away plan view of an antenna unit installed on a hinge axis in accordance with the present invention;

FIG. 4 is a cross-sectional view of the helical antenna installed on the hinge axis in accordance with the present invention;

FIG. 5a is a schematic view of a conventional helical antenna installed on a portable telephone terminal;

FIG. 5b is a schematic view of a helical antenna installed on a portable telephone terminal in accordance with the present invention;

FIG. 6a is a graph showing a relation between frequency and gain of the conventional helical antenna;

FIG. 6b is a graph showing a relation between frequency and gain of the helical antenna in accordance with the present invention;

FIG. 7a is a graph showing a relation between azimuth angle and gain of the conventional helical antenna;

FIG. 7b is a graph showing a relation between azimuth angle and gain of the helical antenna in accordance with the present invention;

FIG. 8a is a graph showing a relation between elevation angle and gain of the conventional helical antenna; and

FIG. 8b is a graph showing a relation between elevation angle and gain of the helical antenna in accordance with the present invention.

### DETAILED DESCRIPTION OF THE PREFERRED EMBODIMENTS

Preferred embodiments of the present invention will be described in detail with reference to the annexed drawings. In the drawings, the same or similar elements are denoted by the same reference numerals even though they are depicted in different drawings. In the following description, well-known functions and configurations are not described in detail since they would obscure the invention in unnecessary detail.

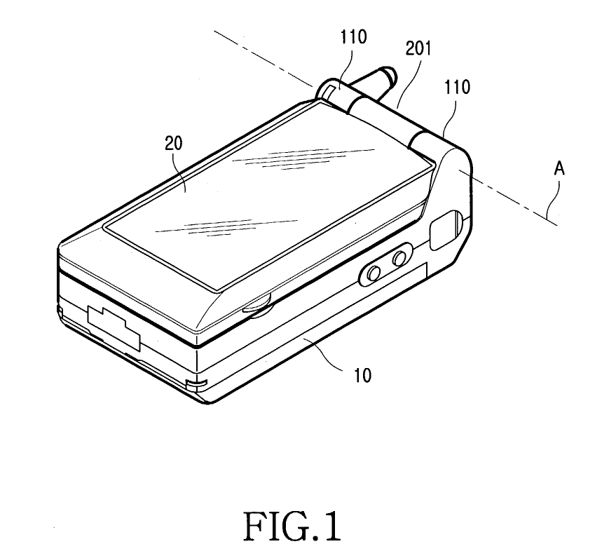

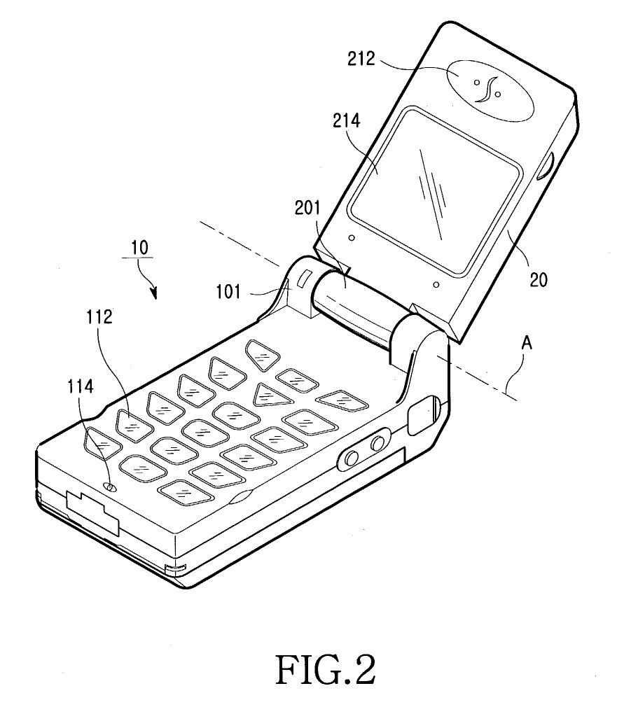

FIGS. 1 and 2 shows a portable telephone terminal employing an antenna unit in accordance with a preferred embodiment of the present invention in a closed and open status of a folder of the terminal, respectively. As shown in FIGS. 1 and 2, the portable telephone terminal comprises a main housing 10, a folder housing 20, and hinge means. The hinge means rotatably connects the folder housing 20 to the main housing 10, thereby allowing the opening and closing of the folder housing 20 from and into the main housing 10. That is, the folder housing 20 rotatably moves on a hinge axis A within a designated angle range. The main housing 10 comprises a keypad consisting of a plurality of keys 112 for inputting data , and a microphone unit 114. The folder housing 20 comprises a speaker unit 212 and a LCD 214 for displaying data.

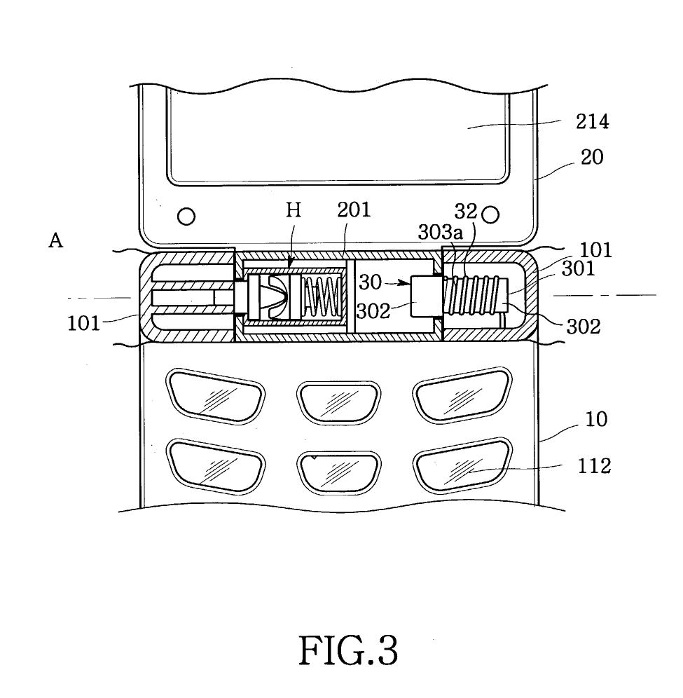

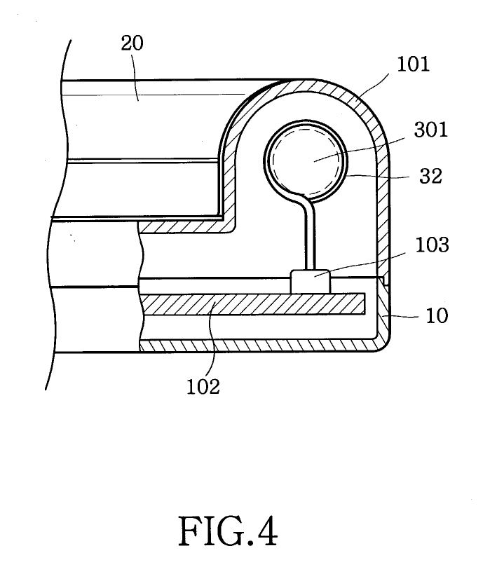

FIGS. 3 and 4 show the helical antenna unit installed on the hinge axis in accordance with the present invention. As shown in FIGS. 3 and 4, the hinge means installed on hinge axis A comprises two side hinge arms 101, a center hinge arm 201, and a hinge module H, and a hinge dummy 30. Two side hinge arms 101 protrude from the upper side of the main housing 10, and one side hinge arm 101 is symmetrically opposite to the other side hinge arm 101. The center hinge arm 201 is interposed between two side hinge arms 101. The hinge module H and the hinge dummy 30 rotatably connect the center hinge arm 201 to the side hinge arms 101. Hinge module H is installed on one side of the center hinge arm 201, and serves to rotatably connect the center hinge arm 201 to the side hinge arms 101 and to provide a force for opening and closing the folder housing 20 from and into the main housing 10. A first terminal 301 of hinge dummy 30 is installed on one side of hinge arm 101, and a second terminal 302 of hinge dummy 30 is connected to the center hinge arm 201, thereby rotatably connecting the folder housing 20 to the side hinge arm 101. Herein, the hinge dummy 30 functions to rotatably connect the folder housing 20 to the main housing 10. When folder housing 20 rotates on the hinge axis A, the hinge module H also rotates, but hinge dummy 30 does not rotate and is fixed to side hinge arm 101.

First terminal 301 of hinge dummy 30 is disposed within one side of hinge arm 101, and second terminal 302 of hinge dummy 30 is disposed within center hinge arm 201. Herein, the antenna unit of the present invention comprises an outer cylindrical surface 303 of the hinge dummy 30 and an antenna member 32. One end of the antenna member 32 is connected to a printed circuit board 102 provided in the main housing 10, thereby forming a power-feeding portion 103. The antenna member 32 is disposed on first terminal 301 of the hinge dummy 30 and coiled more than one time around the outer cylindrical surface 303 of the hinge dummy 30 . The antenna member 32 is disposed in the same direction as the hinge axis. Preferably, the antenna member 32 is formed as a helical form, and a groove 303a is provided on the outer cylindrical surface 303 in order to firmly install the antenna member 32 on the outer cylindrical surface 303. The groove 303a of the outer cylindrical surface 303 of the hinge dummy 30 is formed as a helical form. Further, the antenna member 32 is made of a metal, more particularly a copper wire. First and second terminals 301 and 302 of the hinge dummy 30 are cylindrical and disposed along the hinge axis A.

Antenna member 32 is disposed in the same direction as the hinge axis A and perpendicular to the lengthwise direction of the main housing 10. The length or diameter of the antenna member 32 may be changed according to the antenna and telephone characteristics. The antenna member 32 may be designed to satisfy the antenna characteristics.

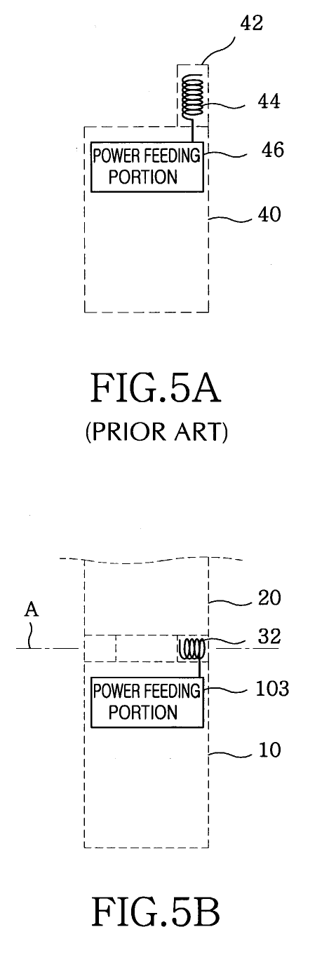

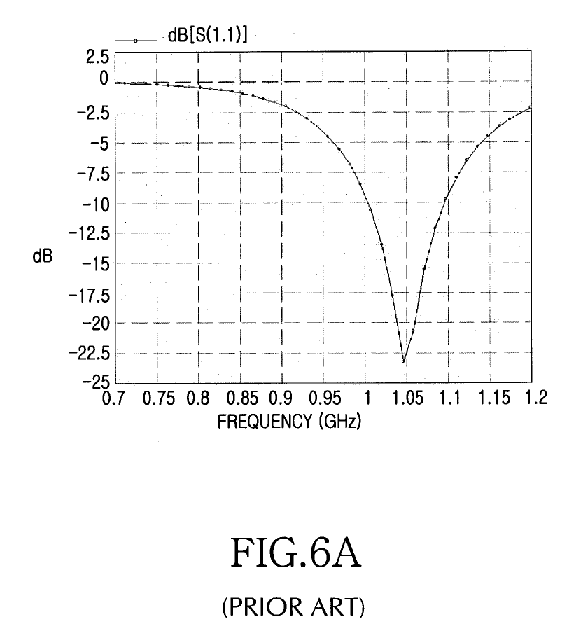

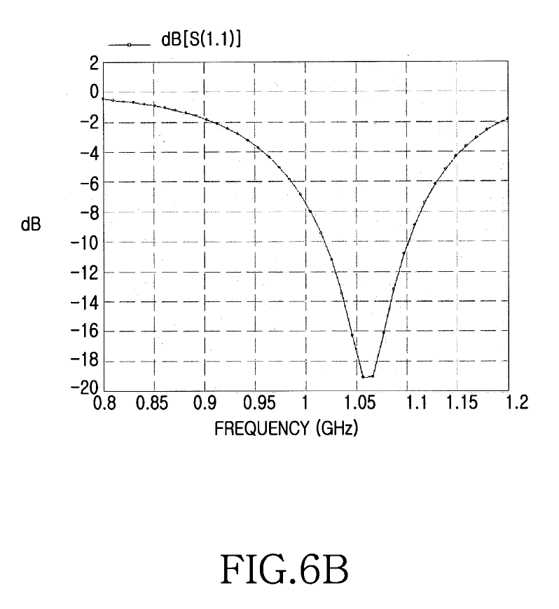

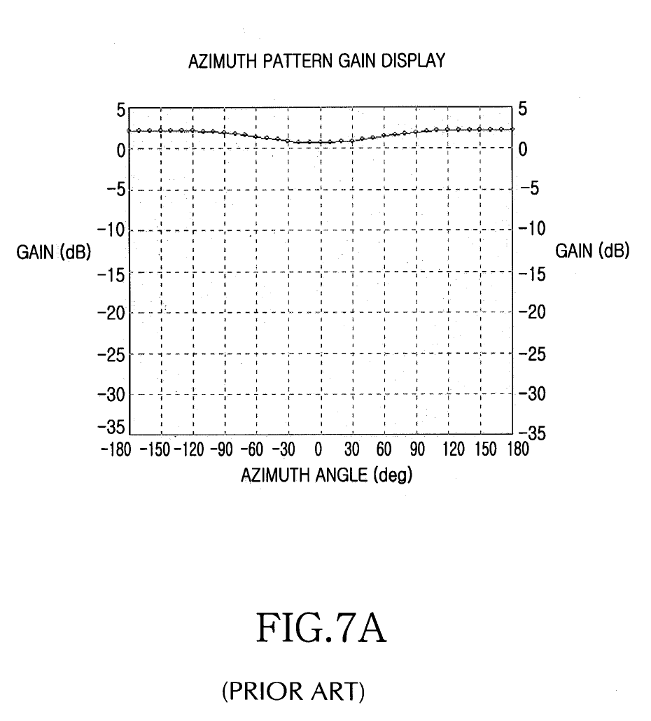

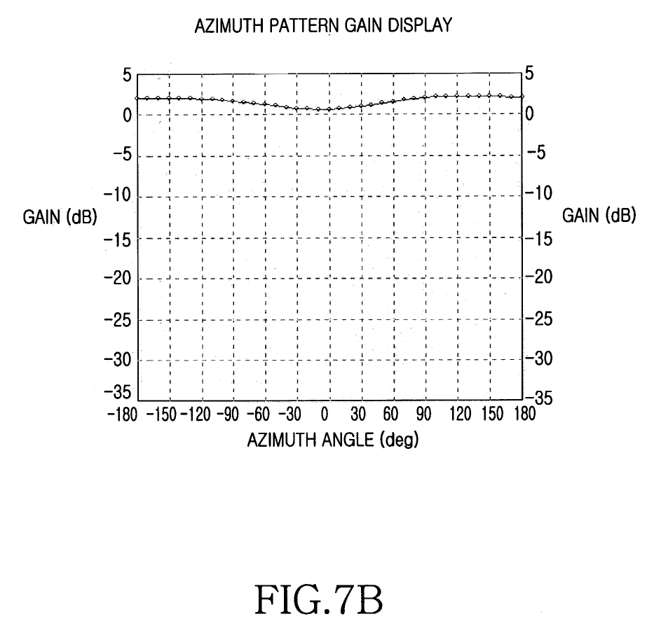

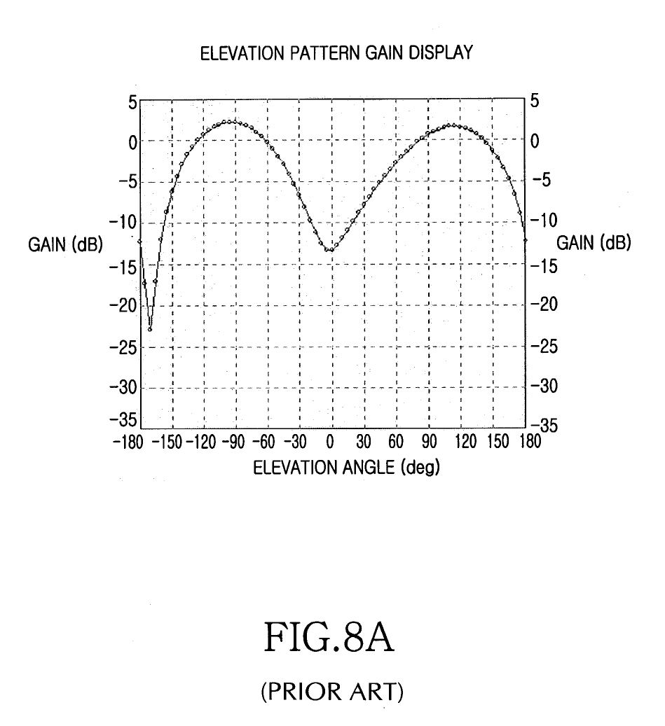

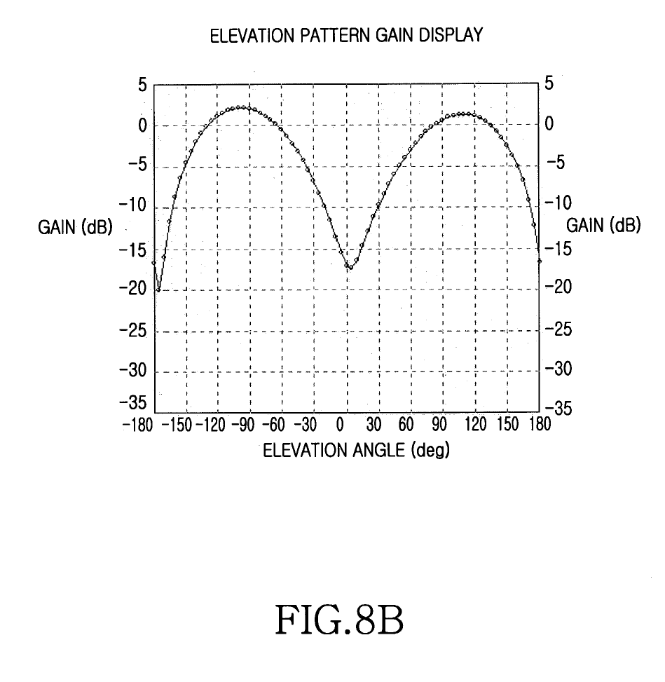

With reference to simulated graphs of FIGS. 6a to 8b, the antenna characteristics of the helical antenna of the present invention shown in FIG. 5b is described in comparison with the conventional helical antenna shown in FIG. 5a. FIG. 6a is a graph showing a relation between frequency and gain of the conventional helical antenna, and FIG. 6b is a graph showing a relation between frequency and gain of the helical antenna in accordance with the present invention. FIG. 7a is a graph showing a relation between azimuth angle and gain of the conventional helical antenna, and FIG. 7b is a graph showing a relation between azimuth angle and gain of the helical antenna in accordance with the present invention. FIG. 8a is a, graph showing a relation between elevation angle and gain of the conventional helical antenna, and FIG. 8b is a graph showing a relation between elevation angle and gain of the helical antenna in accordance with the present invention.

As shown in FIGS. 6a and 6b, the relation between the gain and the frequency of the helical antenna of the present invention and the gain and the frequency of the conventional helical antenna are quite similar. Further, as shown in FIGS. 7a to 8b, the relations between the gain and the azimuth angle/the elevation angle of the helical antenna of the present invention and the gain and the azimuth angle/the elevation angle of the conventional helical antenna are also quite similar. Therefore, the helical antenna of the present invention can be substituted for the conventional helical antenna without any substantial loss in functionality.

Consequently, in accordance with the present invention, a folder type portable telephone terminal employs a helical antenna installed on a hinge space surrounding the hinge dummy on a hinge axis, thereby maximizing space utilization and improving portability of the portable telephone terminal. Although the preferred embodiments of the present invention have been disclosed for illustrative purposes, those skilled in the art will appreciate that various modifications, additions and substitutions are possible, without departing from the scope and spirit of the invention as disclosed in the accompanying claims. For example, the antenna installed on the hinge axis in accordance with the present invention can be used as a supplementary antenna at a BT (blue tooth), GPS band, or so forth, and as a diversity antenna.

As apparent from the above description, according to the present invention, the helical antenna is installed on the hinge axis of the portable telephone terminal, thereby maximizing space utilization, satisfying a miniaturization trend, allowing more flexible designing of an external appearance of a main housing of the portable telephone terminal, and improving portability of the portable telephone terminal.

What is claimed is:

1. A portable telephone terminal having a main housing, a folder housing, hinge means for rotatably connecting the folder housing to the main housing, a hinge dummy installed at one side of a hinge axis between the main housing and the folder housing, and a hinge module installed on the opposite side to the hinge dummy for providing a force for opening and closing the folder housing from and into the main housing, comprising: an outer cylindrical surface provided in a direction of the hinge axis on one side of the hinge dummy; and
an antenna member coiled more than one time around the outer cylindrical surface and means for connecting a first end of the antenna member to an RF (Radio Frequency) output of the portable telephone terminal.

2. The portable telephone terminal as set forth in claim 1, wherein a helical groove is formed on the outer cylindrical surface.

3. The portable telephone terminal as set forth in claim 1, wherein the antenna member is helical in form.

4. The portable telephone terminal as set forth in claim 1, wherein the antenna member is disposed in the same direction as the hinge axis.

5. The portable telephone terminal as set forth in claim 1, wherein the antenna member is made of a copper wire.

6. The portable telephone terminal as set forth in claim 1, wherein the antenna member is perpendicular to the lengthwise direction of the main housing.
